(19) United States
(12) Patent Application Publication
(10) Pub. No.: US 2015/0158406 A1
(43) Pub. Date: Jun. 11, 2015

(54) COOLING AND HEATING CUP HOLDER

(71) Applicants: Hyundai Motor Company, Seoul (KR); Kbautotech Co., Ltd., Asan-si (KR)

(72) Inventors: Man Ju Oh, Yongin-si (KR); Jae Woong Kim, Hwaseong-si (KR); Jae Woo Park, Ansan-si (KR); Jae Hoon Kim, Cheonan-si (KR)

(73) Assignees: Hyundai Motor Company, Seoul (KR); Kbautotech Co., Ltd., Asan-si (KR)

(21) Appl. No.: 14/285,331

(22) Filed: May 22, 2014

(30) Foreign Application Priority Data
Dec. 6, 2013 (KR) 10-2013-0151890

(51) Int. Cl. B60N 3/10; B60H 1/00; F25B 21/04

(52) U.S. Cl. CPC B60N 3/104; F25B 21/04; B60H 1/00478; F25B 2321/02

(57) ABSTRACT

A cooling/heating cup holder includes: a pair of cup-holder bodies facing each other; a pair of thermoelectric elements disposed on the sides facing each other of the cup-holder bodies; a pair of heat radiation fins disposed at a predetermined distance from sides of the cup-holder bodies and facing each other; a heat radiation housing surrounding the heat radiation fins; a blower disposed in the heat radiation housing to enable the heat radiation fins to exchange heat; and a heat pipe thermally connecting the heat radiation fins, with one end in surface contact with the sides facing each other of the thermoelectric elements and the other end in surface contact with the heat radiation fins.

### CROSS-REFERENCE TO RELATED APPLICATION

The present application claims priority of Korean Patent Application Number 10-2013-0151890 filed Dec. 6, 2013, the entire contents of which application is incorporated herein for all purposes by this reference.

### BACKGROUND OF INVENTION

1. Field of Invention

The present invention relates to a cooling/heating cup holder that is mounted on a vehicle and can hold and heat/cool a cup.

2. Description of Related Art

Cup holders are mounted on vehicles. Most of the cup holders have the function of simply holding cups, but there are cup holders having the function of cooling/heating a cup in some vehicles.

However, those cup holders of the related art generally cool/heat cup, using only heat conduction, so there was a problem in that cups are not sufficiently cooled/heated by heat conduction.

FIG. 1 shows a heating/cooling cup holder of the related art, which uses a Peltier device 20, but heat is transferred to a cup holder body 10 only by conduction and the cup in the body is cooled/heated.

However, this configuration has a problem in that cooling/heating by heat conduction is not sufficient when the contact area between the cup and the cup holder is small. The sizes of cups and the cup holder are not always the same, there are cups with recessed bottoms, and there is little heat transfer by conduction in cups made of paper with low thermal conductivity, so the temperature of the cups maintains an equilibrium with the temperature around the cups.

Therefore, there was a need of a cup holder that can practically and efficiently cool/heat cups by solving these problems.

Further, U.S. Pat. No. 5,720,171 for “Device for heating and cooling a beverage” also proposes a cup holder, but it achieves cooling/heating by conduction, so there was a problem in that the efficiency of cooling/heating is very low in practice.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a cooling/heating cup holder that is mounted on a vehicle and can hold and heat/cool a cup.

A cooling/heating cup holder according to an aspect of the present invention includes: a pair of holder bodies facing each other; a pair of thermoelectric elements disposed on the sides facing each other of the holder bodies; a pair of heat radiation fins disposed at a predetermined distance from sides of the holder bodies and facing each other; a heat radiation housing surrounding the heat radiation fins; a blower disposed in the heat radiation housing to enable the heat radiation fins to exchange heat; and a heat pipe thermally connecting a pair of the heat radiation fins, with one end in surface contact with the sides facing each other of a pair of the thermoelectric elements and the other end in surface contact with a pair of the heat radiation fins.

The holder bodies may be made of heat conductive metal.

The thermoelectric elements may be in surface contact with the sides of the corresponding holder bodies, respectively.

The heat radiation fins may be arranged in parallel in straight lines made by a pair of the holder bodies at a predetermined distance from the holder bodies and face each other.

In the heat pipe, both sides of one end may be in surface contact with the thermoelectric elements facing each other, a first bend may be formed and extend to the heat radiation fins, a second bend may be formed and the other end may be disposed between the heat radiation fins, and both sides of the other end may be in surface contact with the heat radiation fins facing each other.

The heat pipe may be composed of a first pipe and a second pipe, the first pipe may be connected such that a first thermoelectric element and a first heat radiation fin exchange heat, and the second pipe may be connected such that a second thermoelectric element and a second heat radiation fin exchange heat.

The first pipe and the second pipe may be arranged in parallel along the same path and may have ends disposed between the thermoelectric elements facing each other in surface contact with the thermoelectric elements, respectively, first bends being formed and extending to the heat radiation fins, second bends being formed and the other ends being in surface contact with the heat radiation fins facing each other.

The first pipe and the second pipe may have ends disposed between the thermoelectric elements facing each other in surface contact with the thermoelectric elements, respectively, first bends being formed and extended to the heat radiation fins, second bends being formed and the other ends being in surface contact with the heat radiation fins facing each other.

The first pipe and the second pipe may have ends disposed between the thermoelectric elements facing each other in surface contact with the thermoelectric elements, respectively, first bends being formed and extended to the heat radiation fins, and second bends being formed, in which the other end of the first pipe may be disposed between the heat radiation fins facing each other, with both sides in surface contact with the heat radiation fins, respectively, and the second pipe may be in surface contact with the outer side of one of the heat radiation fins.

The first pipe and the second pipe may be disposed along opposite paths, with predetermined ends disposed between the thermoelectric elements facing each other in surface contact with the thermoelectric elements, respectively, may extend away from each other in the opposite directions, and may have first bend extending to the heat radiation fins, second bends formed such that the pipes extend close to each other, and the other ends being in surface contact with the heat radiation fins, respectively.

According to the cooling/heating cup holders having the structures described above, since all of pairs of heat pipes, thermoelectric elements, and heat radiation fins are thermally connected, the efficiency of cooling/heating can be increased.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a cooling/heating cup holder of the related art; and

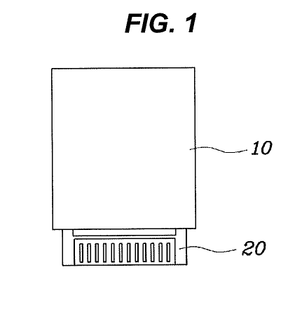

FIG. 2 is a view showing an exemplary cooling/heating cup holder according to the present invention.

FIG. 3 is a view showing an exemplary cooling/heating cup holder according to the present invention.

FIG. 4 is a view showing an exemplary cooling/heating cup holder according to the present invention.

FIG. 5 is a view showing an exemplary cooling/heating cup holder according to the present invention.

FIG. 6 is a view showing an exemplary cooling/heating cup holder according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

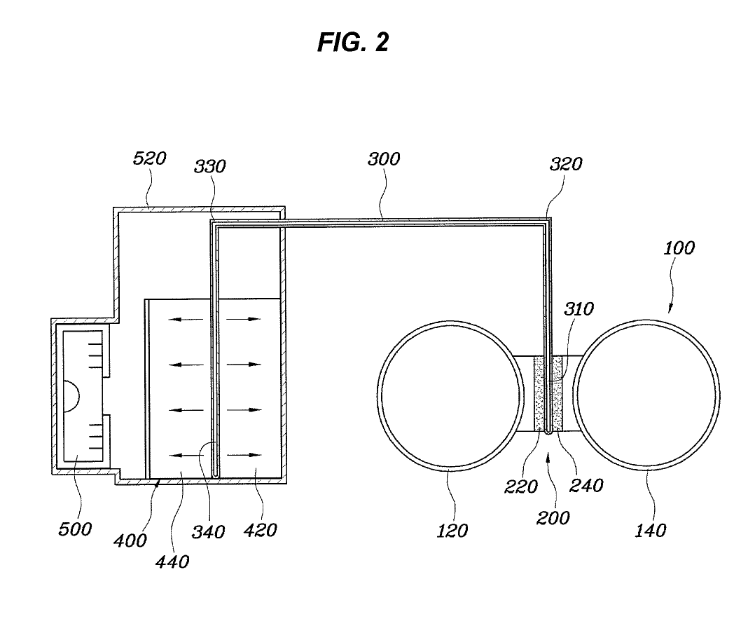

FIGS. 2 to 6 are views showing cooling/heating cup holders according to various embodiments of the present invention and a cooling/heating cup holder of the present invention includes: a pair of holder bodies or cup-holder bodies 100 facing each other; a pair of thermoelectric elements 200 on the sides facing each other of the holder bodies 100; a pair of heat radiation fins 400 facing each other at a predetermined distance from a side of the holder bodies 100; a heat radiation housing 520 surrounding the heat radiation fins; a blower 500 disposed in the heat radiation housing 520 and enabling the heat radiation fins 400 to exchange heat; and a heat pipe 300 thermally connecting the pair of heat radiation fins 400, with one end 310 in surface contact with the sides facing each other of the pair of thermoelectric elements 200 and the other end in surface contact with the pair of heat radiation fins 400. The holder bodies 100 may be made of heat conductive metal.

First, the pair of holder bodies 100 is provided. Cups are cooled/heated in the holder bodies 100, and the same is achieved basically by the thermoelectric elements 200. The thermoelectric elements 200 have an air-conditioning side for taking/radiating heat and a corresponding heat-radiating side for radiating heat, in which the air-conditioning side is on each of the holder bodies 100, so they are provided in a pair, corresponding to the holder bodies 100. Obviously, it should be noted that when the holder bodies 100 are provided in more than a pair, the components to be described below are all provided in the corresponding number.

The holder bodies 100 are arranged in a pair facing each other. The holder bodies 100 may be made of heat conductive metals. The pair of thermoelectric elements 200 is disposed on the sides facing each other of the holder bodies 100. The pair of heat radiation fins 400 is disposed at a predetermined distance from a side of the holder bodies 100, facing each other.

The heat radiation housing 520 surrounds the pair of heat radiation fins 400. The blower 500 is disposed in the heat radiation housing 520 and enables the radiation fins 400 to exchange heat.

For heat exchange of the heat radiation fins 400 and the thermoelectric elements 200, one end 310 of the heat pipe 300 is in surface contact with the sides facing each other of the pair of thermoelectric elements 200 and the other end 340 is in surface contact with the pair of heat radiation fins 400, so the resultant heat by cooling/heating of the thermoelectric elements 200 can be radiated.

Accordingly, when the pair of cup holders is used for cooling/heating in a narrow layout, the configuration can be made compactly, and the efficiency is further increased because the heat radiation fins are shared.

The pair of thermoelectric elements 200 may be disposed in surface contact with the sides of the corresponding holder bodies 100, respectively.

Further, the pair of heat radiation fins 400 is arranged in parallel in the straight lines made by the pair of holder bodies 100, at a predetermined distance from a pair of the holder bodies 100, and they may face each other.

As in FIG. 2, in the heat pipe 300, both sides of one end 310 are in surface contact with the thermoelectric elements 220 and 240 facing each other, a first bend 320 is formed and extends to the heat radiation fins 420 and 440, a second bend 330 is formed and the other end 340 is disposed between the heat radiation fins 420 and 440 facing each other, and both sides of the other end 340 are in surface contact with the heat radiation fins 420, 440 facing each other. Therefore, the thermoelectric elements 220, 240 and the heat radiation fins 420, 440 are thermally connected by one heat pipe 300, thereby increasing the efficiency of the thermoelectric elements.

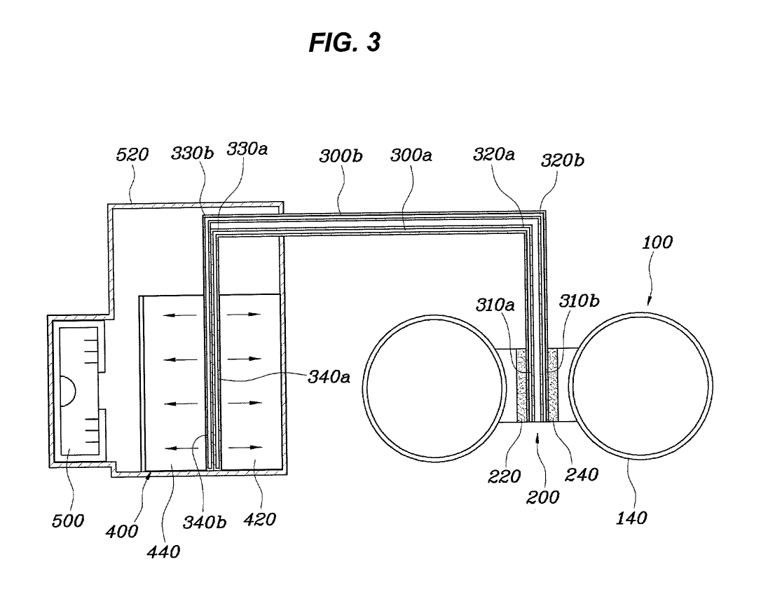

On the other hand, in FIG. 3, the heat pipe 300 is composed of a first pipe 300a and a second pipe 300b, the first pipe 300a may be connected such that the first thermoelectric element 220 and the first heat radiation fin 420 exchange heat and the second pipe 300b may be connected such that the second thermoelectric element 240 and the second heat radiation fin 440 exchange heat.

In this configuration, the first pipe 300a and the second pipe 300b are arranged in parallel along the same path and have the ends 310a and 310b disposed between the thermoelectric elements 220 and 240 facing each other in surface contact with the thermoelectric elements 220 and 240, respectively, first bends 320a and 320b extending to the heat radiation fins 420 and 440, second bends 330a and 330b being formed, and the other ends 340a and 340b being in surface contact with the heat radiation fins 420 and 440 facing each other.

That is, the first thermoelectric element 220 and the second thermoelectric element 240 are arranged opposite to each other, and between the elements, the end 310a of the first pipe 300a is in contact with the first thermoelectric element 220 and the second pipe 300b is in contact with the second thermoelectric element 240. Further, they are bent in the same direction and extend to between the first heat radiation fin 420 and the second heat radiation fin 440. The other ends 340a and 340b of the pipes 300a and 300b are in contact with each other and with the heat radiation fins 420 and 440, respectively, so they are thermally connected.

In this configuration, heat transfers through the first pipe 300a in cooling operation of the first thermoelectric element 220. Heat is radiated through both of the first heat radiation fin 420 and the second heat radiation fin 440. Further, heat is radiated in the same way even in cooling operation of both of the first thermoelectric element 220 and the second thermoelectric element 240. In particular, it can be seen that when the first thermoelectric element 220 performs cooling and the second thermoelectric element 240 performs heating, the wasted heat from the first thermoelectric element 220 transfers to the second thermoelectric element 240 through the heat radiation fins 420 and 440, and thus the efficiency of cooling and heating is further increased.

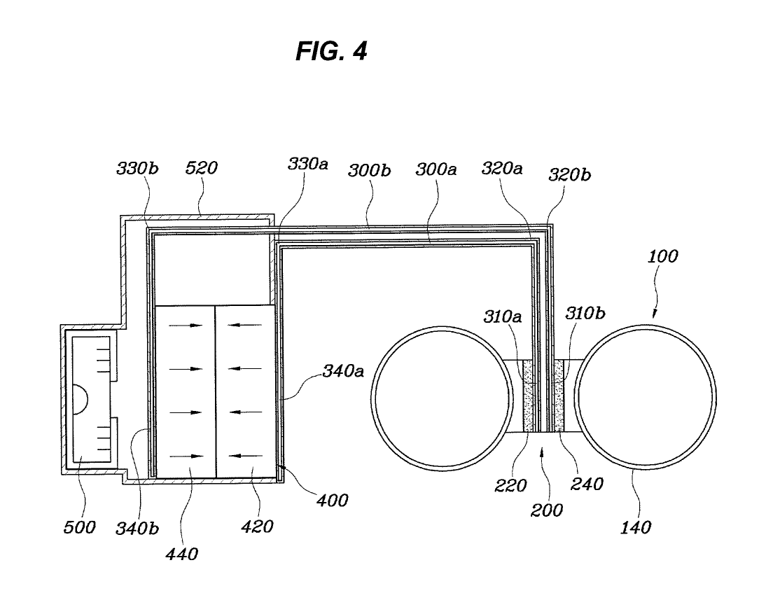

In this configuration shown in FIG. 4, the first pipe 300a and the second pipe 300b have the ends 310a and 310b disposed between the thermoelectric elements 220 and 240 facing each other in surface contact with the thermoelectric elements 220 and 240, respectively, first bends 320a and 320b extending to the heat radiation fins 420 and 440, second bends 330a and 330b being formed and the other ends 340a and 340b being in surface contact with the outer sides of the heat radiation fins 420 and 440 facing each other, respectively.

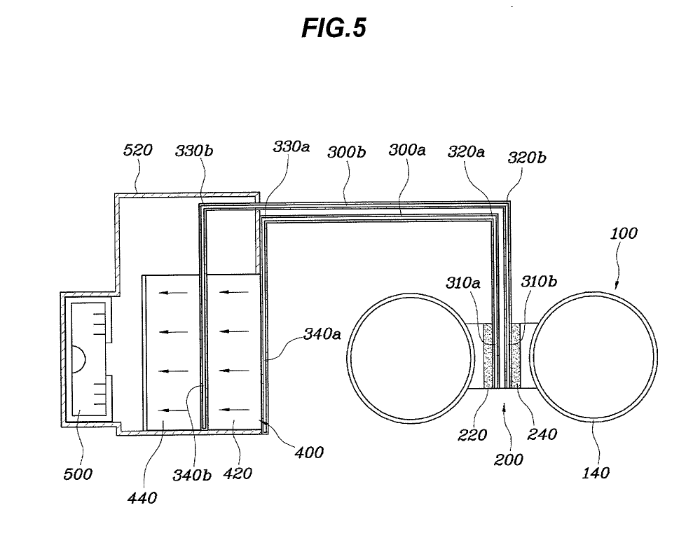

In this configuration shown in FIG. 5, the first pipe 300a and the second pipe 300b have the ends 310a and 310b disposed between the thermoelectric elements 220 and 240 facing each other in surface contact with the thermoelectric elements 220 and 240, respectively, first bends 320a and 320b extending to the heat radiation fins 420 and 440, and second bends 330a and 330b being formed, in which the other end 340a of the first pipe 300a is disposed between the heat radiation fins 420 and 440, with both sides in surface contact with the heat radiation fins 420 and 440 facing each other, respectively, and the second pipe 300b is in surface contact with the outer side of the heat radiation fin 420.

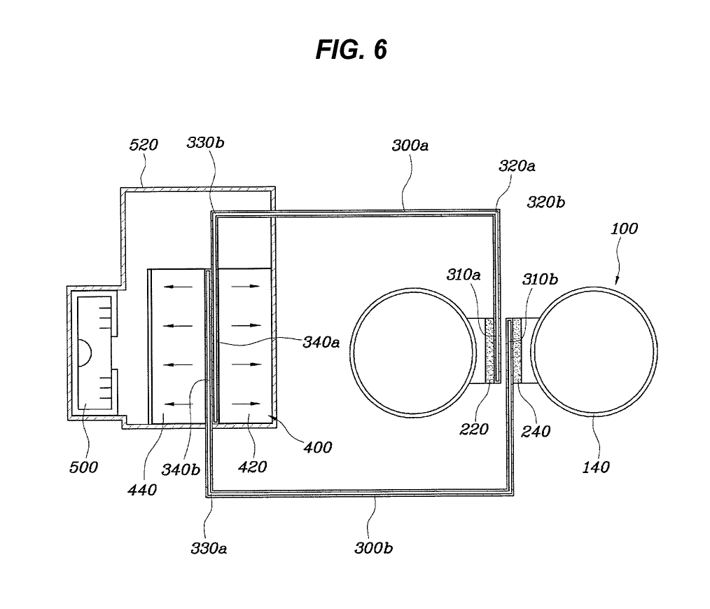

In this configuration shown in FIG. 6, the first pipe 300a and the second pipe 300b are disposed along opposite paths, with the ends 310a and 310b disposed between the thermoelectric elements 220 and 240 facing each other in surface contact with the thermoelectric elements 220 and 240, respectively, extend away from each other in the opposite directions, and have first bend 320a and 320b extending to the heat radiation fins 420 and 440, second bends 330a and 330b formed such that the pipes extend close to each other, and the other ends 340a and 340b being in surface contact with the heat radiation fins 420 and 440, respectively.

According to the cooling/heating cup holders having the structures described above, since all of pairs of heat pipes, thermoelectric elements, and heat radiation fins are thermally connected, the efficiency of cooling/heating can be increased.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cooling/heating cup holder comprising:
a pair of cup-holder bodies including sides facing each other;
a pair of thermoelectric elements, each disposed on a respective side of the cup-holder bodies;
a pair of heat radiation fins disposed at a predetermined distance from the sides of the cup-holder bodies, the pair of head radiation fins facing each other;
a heat radiation housing surrounding the heat radiation fins;
a blower disposed in the heat radiation housing to enable the heat radiation fins to exchange heat; and
a heat pipe thermally connecting the heat radiation fins, with one end of the heat pipe in surface contact with the thermoelectric elements, and another end of the heat pipe in surface contact with the heat radiation fins.

2. The cooling/heating cup holder of claim 1, wherein the cup-holder bodies are made of heat conductive metals.

3. The cooling/heating cup holder of claim 1, wherein the thermoelectric elements are in surface contact with the sides of the corresponding cup-holder bodies, respectively.

4. The cooling/heating cup holder of claim 1, wherein the heat radiation fins are arranged in parallel in straight lines made by the cup-holder bodies at a predetermined distance from the cup-holder bodies and faced each other.

5. The cooling/heating cup holder of claim 1, wherein in the heat pipe, opposing sides of one end are in surface contact with the thermoelectric elements facing each other, a first bend is formed and extends toward the heat radiation fins, a second bend is formed and extends toward the other end of the heat pipe disposed between the heat radiation fins, wherein opposing sides of the other end are in surface contact with the heat radiation fins facing each other.

6. The cooling/heating cup holder of claim 1, wherein the heat pipe is composed of a first pipe and a second pipe, the first pipe is connected such that a first thermoelectric element and a first heat radiation fin exchange heat, and the second pipe is connected such that a second thermoelectric element and a second heat radiation fin exchange heat.

7. The cooling/heating cup holder of claim 6, wherein the first pipe and the second pipe are arranged in parallel along the same path and have ends disposed between the thermoelectric elements facing each other in surface contact with the thermoelectric elements, respectively, first bends extending to the heat radiation fins, second bends being formed, and other ends being in surface contact with the heat radiation fins facing each other.

8. The cooling/heating cup holder of claim 6, wherein the first pipe and the second pipe have ends disposed between the thermoelectric elements facing each other in surface contact with the thermoelectric elements, respectively, first bends being formed and extended to the heat radiation fins, second bends being formed, and the other ends being in surface contact with the heat radiation fins facing each other.

9. The cooling/heating cup holder of claim 6, wherein the first pipe and the second pipe have ends disposed between the thermoelectric elements facing each other in surface contact with the thermoelectric elements, respectively, first bends being formed and extended to the heat radiation fins, and second bends being formed, the other end of the first pipe is disposed between the heat radiation fins facing each other, with opposing sides in surface contact with the heat radiation fins, respectively, and the second pipe is in surface contact with the outer side of one of the heat radiation fins.

10. The cooling/heating cup holder of claim 1, wherein the first pipe and the second pipe are disposed along opposite paths, with predetermined ends disposed between the thermoelectric elements facing each other in surface contact with the thermoelectric elements, respectively, extend away from each other in the opposite directions, and have first bend extending to the heat radiation fins, second bends formed such that the pipes extend close to each other, and the other ends being in surface contact with the heat radiation fins, respectively.
